(19) United States
(12) Patent Application Publication
(10) Pub. No.: US 2023/0402788 A1
(43) Pub. Date: Dec. 14, 2023

(54) CONNECTING DEVICE

(71) Applicant: Grawe GmbH, Sachsenkam (DE)

(72) Inventor: Michael GRAWE, Prag (CZ)

(21) Appl. No.: 18/330,834

(22) Filed: Jun. 7, 2023

(30) Foreign Application Priority Data
Jun. 8, 2022 (DE) 10 2022 114 441.0

(51) Int. Cl. H01R 13/625; H01R 13/504

(52) U.S. Cl. CPC H01R 13/625; H01R 13/504

(57) ABSTRACT

A connecting device for connecting electrical cables, comprising an arrangement of electrical contacts, wherein a plurality of first electrical contacts is arranged around at least one second electrical contact, each of the first electrical contacts having a substantially equal distance from the at least one second electrical contact, and an arrangement of clamping units, each clamping unit having at least two clamping receptacles which are each configured to receive an electrical conductor, and in a lockable and releasable manner such that a release of the electrical conductor from a respective clamping receptacles is prevented in the locked state below a predetermined release force, and permitted in the unlocked state, wherein each of the electrical contacts is electrically connected to a clamping unit.

### CROSS REFERENCE TO RELATED APPLICATION

This application claims priority to German Patent Application No. 10 2022 114 441.0, filed in Germany on Jun. 8, 2022, the entire contents of which are hereby incorporated herein by this reference.

### TECHNICAL FIELD

The present invention relates to a connecting device for connecting electrical cables.

It is generally known from the prior art that electrical devices, such as headlights, can be connected using electrical cables in order to supply power to the electrical device. It is also generally known that two electrical cables can be connected to one another in order to obtain a lengthened electrical line.

However, these cable connections are often difficult to replace or repair in individual parts, if at all.

### SUMMARY

It is therefore the object of the present invention to provide a connecting device for connecting electrical cables which improves the ability to exchange parts.

According to the invention, this object is achieved by a connecting device for connecting electrical cables, comprising:
an arrangement of electrical contacts which are configured to enter on the plug-and-socket principle into electrically conductive contact with a complementary arrangement of electrical contacts, wherein a plurality of first electrical contacts is arranged around at least one second electrical contact, wherein each of the first electrical contacts has a substantially equal distance from the at least one second electrical contact, and
an arrangement of clamping units, wherein each clamping unit has at least two clamping receptacles, each of which is configured to receive an electrical conductor in a reproducible manner and in a lockable and releasable manner, in such a way that a release of the electrical conductor from a respective clamping receptacle in the locked state is prevented below a predetermined release force, and is allowed in the unlocked state,
wherein each of the electrical contacts is electrically connected to a clamping unit.

In this context, “reproducible” is intended to mean that an electrical conductor can be inserted repeatedly into a clamping receptacle, locked in the clamping unit, unlocked, removed from the clamping receptacle, and re-inserted (or, optionally, another electrical conductor is inserted) into the clamping receptacle, etc.

The connecting device is part of a plug-and-socket combination for connecting two electrical cables, wherein the connecting device according to the invention can be designed not only as a plug but also as a socket. In the case of the plug, the electrical contacts can advantageously be designed as pin-like projections. In the case of the socket, the electrical contacts can advantageously be designed as recesses.

In particular, the at least one second contact can be connected to a grounding line of the electrical cable, and/or the first electrical contacts can be connected to phases of the electrical cable.

An example of an embodiment according to the present invention is a 5- or 7-pole plug contact in which a contact, usually the grounding contact, is arranged centrally and the remaining 4 or 6 contacts are arranged in a circular manner around this central contact.

The connecting device according to the invention thus makes it possible for it to be disassembled without tools, that is to say without the use of a special tool, after which the clamping connections of the connecting device to the electrical cable can be released. Depending on the case in which a repair is performed, for example, a replacement connecting device can be connected to the electrical cable, or another, a shortened, or a repaired electrical cable can be connected to the connecting device.

The arrangement of clamping units can be overlapped radially on the outside by a cover which prevents direct and possibly unintentional contact with the clamping units and/or the electrical lines. In this case, the cover can consist of several, for example two or three, sub-components which are formed in a substantially identical manner and form the cover when they are fitted.

In the event that components of the connecting device according to the invention which are intended to be touched by a user are made of plastic, the plastic itself can provide a necessary insulation of the electrically conductive components with respect to the user. However, in the event that components of the connecting device according to the invention which are intended to be touched by a user are made of metal, a grounding of these components can be provided. In this case, a metal ring can in particular be arranged in contact with these components, which metal ring is in electrical connection with the above-mentioned grounding line. The connection of the metal ring to the grounding line can comprise a wire strand or a substantially rigid rib, which is integrated into, for example cast or overmolded onto, a connection base body formed from plastic. The metal ring can be arranged at an axial position at which it surrounds the arrangement of electrical contacts radially on the outside.

In a further development of the present invention, the arrangement of clamping units can comprise a plurality of first clamping units which are arranged around at least one second clamping unit, wherein each first clamping unit has substantially the same distance from the at least one second clamping unit. This arrangement of the clamping units can be an arrangement which is suitable for the arrangement of the electrical contacts—that is to say, the same arrangement. Furthermore, this arrangement can allow electrical connections to run substantially in a straight line between the electrical contacts and the clamping units. That is to say, such an electrical connection can run along a shortest path from an electrical contact to a respective clamping unit.

In this case, a free end of the at least one second clamping unit, viewed in an axial direction, can extend further outwards than the corresponding free ends of the first clamping units. This makes it possible to connect the corresponding electrical conductor to the central (second) clamping unit first and then to connect the first clamping units to the respective electrical conductors. As a result, a simplified assembly can be ensured.

In particular, the number of clamping units can correspond to the number of electrical contacts. A single respective electrical contact can thus be connected to a single respective clamping unit, such that the contact pattern of the plug or the socket can be reflected by the arrangement of the clamping units.

Furthermore, a clamping unit can have an elongated shape with two opposite longitudinal ends, and one of the two clamping receptacles of the clamping unit can be arranged at each longitudinal end, wherein in particular all clamping units can be arranged substantially parallel to one another. By means of the two clamping receptacles of a clamping unit, not only can an electrical conductor which is assigned to at least one of the electrical contacts be connected on the one side to the clamping unit without tools; but also an electrical conductor which is assigned to the electrical cable can be connected on the other side to a clamping unit without tools.

In possible embodiments of the present invention, the arrangement of clamping units can comprise a base body on which the clamping units are held. The base body can define fixed relative positions of the clamping units relative to one another, in particular by means of suitable receptacles for the clamping units.

In this case, the base body of the arrangement of clamping units may be made of plastic. In particular using an injection-molding process, the base body can thus be producible in a cost-optimized and weight-optimized manner.

The electrical contacts can be accommodated in a connection base body and be fixedly positioned relative to one another by the latter. A desired arrangement of the electrical contacts can thus be prespecified and maintained during the use of the connecting device.

In this context, the connection base body can be made of plastic. Here too, the base body can be producible in a cost-optimized and weight-optimized manner by the use of an injection-molding process. An embodiment of the connection base body made of plastic can also achieve an insulation of the arrangement of electrical contacts with respect to one another.

Advantageously, the base body of the arrangement of clamping units can be configured to engage with the connection base body in such a way that the base body of the arrangement of clamping units is at least rotationally secured, and in particular is also secured for translational movements, relative to the connection base body. This can be achieved, for example, by providing at least one projection on one of the two components, which is configured and arranged to engage with a corresponding recess on the respective other component. Damage to the electrical connections can be prevented in this way.

The connecting device can further comprise a protective sleeve which surrounds at least the base body of the arrangement of clamping units on the outer side thereof, and which is connectable to the connection base body. The connection of the protective sleeve to the connection base body can be watertight, in particular by using suitable sealing means.

The connection base body and the protective sleeve can be connected to one another via a threaded engagement, for example. For example, the connection base body can have an external thread with which an internal thread of the protective sleeve can engage.

In a further development of the present invention, the connecting device can further comprise a strain relief feature which is connectable to the protective sleeve and which is configured to prevent a displacement of a cable connected thereto, at least in an axial direction. For this purpose, the strain relief feature can comprise radially inwardly displaceable projections for engagement with a cable guided through the strain relief feature. The projections can, for example, be displaced radially inward by screwing the strain relief feature onto the protective sleeve. Alternatively or additionally, a ring can be arranged on the cable to be secured in an axially immovable manner, which ring is retained by the strain relief feature connected to the protective sleeve, at least in the axial direction away from the protective sleeve. As a result, loads on the clamping receptacles can be reduced or even prevented.

In possible embodiments of the present invention, the protective sleeve may comprise a substantially cylindrical body and a threaded ring provided with a thread, wherein the threaded ring is freely rotatable relative to the cylindrical body in a circumferential direction thereof and is secured in an axial direction thereof.

The protective sleeve can be constructed in several parts, in particular in two parts, wherein a radially inner part of the protective sleeve can be arranged substantially coaxial with a radially outer part and, in the mounted state, can run through it. In particular, the radially outer part of the protective sleeve can be configured to engage with the connection base body in such a way that the radially outer part of the protective sleeve is secured at least rotationally relative to the connection base body. In this case, in one of the predetermined connection positions of the radially outer part of the protective sleeve relative to the connection base body, a connection of the radially inner part of the protective sleeve to the connection base body can be prevented. This can be achieved, for example, by virtue of the fact that the radially inner part of the protective sleeve can only be guided through the radially outer part of the protective sleeve until the two parts reach abutment with one another.

This radially outer part of the protective sleeve can be produced using a two-component injection-molding process, and can comprise at least two different materials. The radially outer part of the protective sleeve can thus have sections with different coefficients of friction, and/or sections with different colors.

According to a further aspect, the invention can relate to a plug arrangement which comprises two connecting devices according to the invention that are complementary and connectable to one another on the plug-and-socket principle. These two connecting devices can be locked to one another using bayonet closure components that are suitable for one another.

### BRIEF DESCRIPTION OF THE DRAWINGS

It should be noted at this point that in particular the connection base body of the connecting device according to the invention can be made of metal, advantageously using a metal-casting process. The metal ring described further above can form an integral component of the connection base body. Furthermore, at least the second clamping unit can be provided with a securing element, such as an elastic band, a piece of elastic tubing, or an adhesive tape, in order to prevent unintentional opening of the clamping unit. To open the second clamping unit, the securing element must thus first be removed. Furthermore, the protective sleeve, in particular the outer part of the protective sleeve, can have at least one elastic buffer element. For example, an elastic rubber ring can thus be arranged at each longitudinal end of the outer part of the protective sleeve, which elastic rubber ring can dampen impacts on the protective sleeve—for example, caused by dropping the connecting device—and thus on the entire connecting device, and thus can reduce or even prevent damage.

### DETAILED DESCRIPTION

The present invention will be described in greater detail below by means of an embodiment with reference to the accompanying drawings. In the drawings:

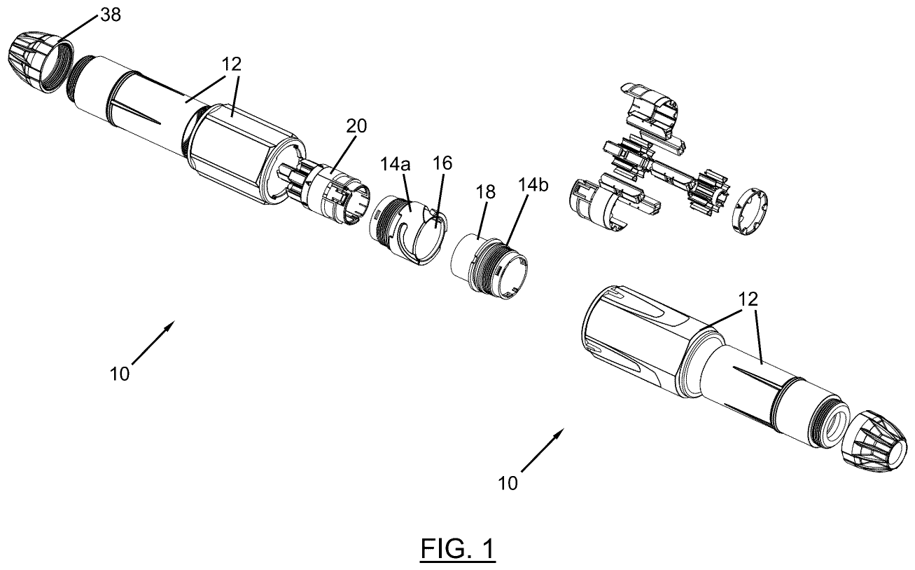

FIG. 1 is a perspective exploded view of two connecting devices according to the invention, which are designed to be connectable to one another;

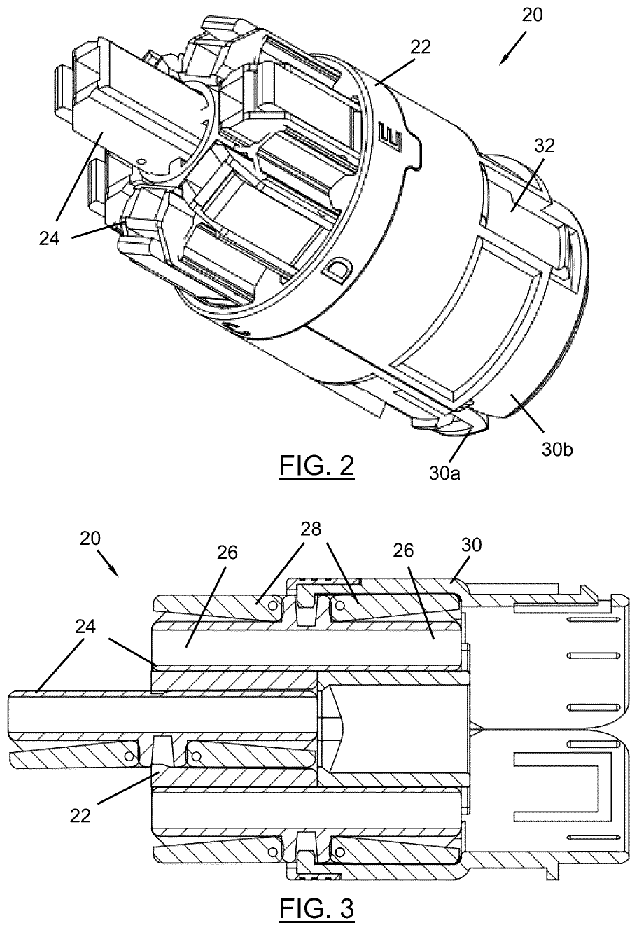

FIG. 2 is a perspective view of an arrangement of clamping units;

FIG. 3 is a side cross-sectional view of the arrangement of clamping units from FIG. 2; and

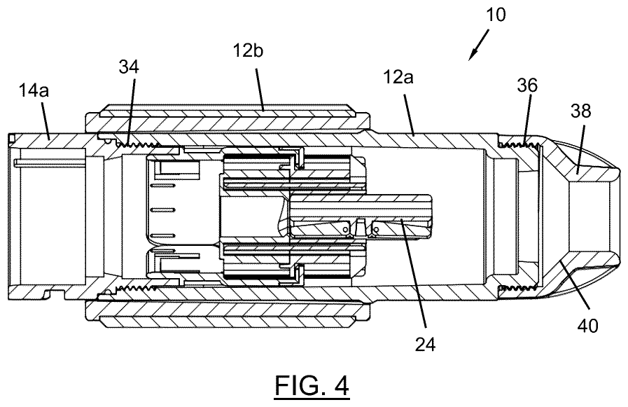

FIG. 4 is a cross-sectional view of a connecting device according to the invention.

Each of two connecting devices according to invention is denoted with reference number 10 in FIG. 1. The two connecting devices 10 of FIG. 1 are largely similar to one another, and differ in particular in that the connecting device 10 shown on the left in FIG. 1 is designed as a female connecting device (socket) and the connecting device 10 shown on the right in FIG. 1 is designed as a male connecting device (plug). Furthermore, it can be seen that each outer protective sleeve 12 of the connecting devices 10 is designed to be slightly different, in particular to have different lengths and external designs, so that a user of the connecting device according to the invention can determine as quickly as possible from the outside whether a connecting device he is using is a male or a female connecting device.

The connecting device 10, which takes the form of a female connecting device in FIG. 1, comprises a connection base body 14a, and the connecting device 10, which takes the form of a male connecting device in FIG. 1, comprises a connection base body 14b. The connection base body 14a has a central recess 16, which is configured to receive a corresponding projection 18 of the connection base body 14b. In the embodiment shown here, a plurality of pin-like protruding electrical contacts is arranged radially within the outer wall of the central projection 18 of the connection base body 14b, wherein this arrangement of electrical contacts has a plurality of first electrical contacts, which are arranged, for example, substantially along a circular path at a uniform distance from one another (of course, a non-uniformly spaced arrangement can be contemplated as well), and there is a second electrical contact which is arranged substantially at the center of this circular path. An arrangement of electrical contacts is also arranged radially within the outer wall which defines the central recess 16 of the connection base body 14a; in this embodiment, they are each designed as sockets for coming into electrically conductive contact with the pin-like electrical contacts of the connection base body 14b. For the arrangement of the electrical contacts, reference is therefore made to the above description.

In the following, the present invention will be further described with reference to the connecting device 10 shown on the left in FIG. 1, wherein all the features, effects and advantages can also be applied to the connecting device 10 shown on the right in FIG. 1.

The connecting device 10 further comprises an arrangement of clamping units 20, which will be described below in particular with reference to FIGS. 2 and 3.

The arrangement of clamping units 20 comprises a base body 22 formed from plastic, on which a plurality of clamping units 24 is arranged. The clamping units 24 each have two clamping receptacles 26, which are electrically connected to one another. Each clamping receptacle 26 comprises a clamping lever 28 which is configured to releasably lock a cable inserted into a respective clamping receptacle 26, and in particular to secure an electrical contact between the cable and the clamping receptacle 26.

As can be seen in particular in FIGS. 2 and 3, the clamping units 24 are arranged analogously to the electrical contacts described further above, so that a first plurality of clamping units is arranged in a substantially circular manner around a second clamping unit in the middle thereof. The free end of the second clamping unit shown on the left in FIGS. 2 and 3 projects further outwards relative to the corresponding free ends of the first clamping units, in particular by approximately half a total length of the second clamping unit. The second clamping unit can in particular be configured to be connected to a grounding line of an electrical cable, wherein the first clamping units can be configured to be connected to respective phases of the electrical cable. The described arrangement of the clamping units 24 thus makes it possible to connect the end of the second clamping unit shown on the left in FIGS. 2 and 3 to the cable in a simple manner first, and then to connect the phases of the electrical cable to the first clamping units. The clamping receptacles 26 of the clamping units 24 shown on the right in FIG. 3 are each connected, in particular using electrical cables, to one of the above-mentioned electrical contacts, which are either designed as sockets or as plugs. Of course, it is also possible for the electrical contacts to be each designed in such a way that their end pointing away from the cylindrical receptacle 16 or the projection 18 is configured to be connected directly to a clamping receptacle of a respective clamping unit 24.

As can be seen in particular in FIG. 2, the base body 22 of the arrangement of clamping units 20 has markings (in this case letters) in order to be able to distinguish the first clamping units 24 from one another in a simple manner.

The side of the base body 22 or of the first clamping units 24 shown on the right in FIGS. 2 and 3 is surrounded radially outside by a cover 30 which comprises two half shells 30a and 30b. In this way, the electrical connection of the clamping units 24 to the electrical contacts can be protected against unintentional manipulation. Furthermore, a latching device 32 formed on the cover 30 allows the arrangement of clamping units 20 to be positively secured to a respective connection base body 14a, 14b. Of course, the cover 30 can also be constructed from three or more partial shells which can be joined together in the circumferential direction to form the cover 30.

With reference to the above-mentioned protective sleeve 12, it can be seen in FIGS. 1 and 4 that the protective sleeve 12 is constructed from an inner part 12a and an outer part 12b, which are designed to be releasable from one another. The inner part 12a of the protective sleeve 12 is substantially a cylindrical hollow body which has an internal thread 34 at its one longitudinal end and an external thread 36 at its opposite other longitudinal end. The internal thread 34 is configured to be connected to a corresponding mating thread of a respective connection base body 14a or 14b. The external thread 36 is configured to be connected to a corresponding mating thread of a strain relief feature 38. The strain relief feature 38 has a central through-opening, the diameter of which substantially corresponds to the outer diameter of an electrical cable with which the connecting device 10 according to the invention is to be connected. In order to prevent a tensile force exerted on the electrical cable from being applied to the connection of the cable to the clamping units 24, a retaining ring can be attached to the cable at a suitable location, i.e., approximately at a distance from the free end of the electrical cable which corresponds to the distance of the first clamping units 24 from the strain relief feature 38, said retaining ring being clamped or screwed onto the electrical cable, for example. Due to the larger outer diameter of the retaining ring, the tensile force exerted on the electric cable is then directed from the electrical cable into the retaining ring, and from the same into the conical inner wall 40 of the strain relief feature 38, and from there into the protective sleeve 12 of the connecting device 10.

The outer part 12b of the protective sleeve 12 can in particular be designed such that it is connectable to the given connection base body 14a, 14b in only a limited number of relative positions, in particular at most three relative positions, more preferably in only a single relative position. In this case, each base body 14a, 14b, the inner part 12a of the protective sleeve 12, and the outer part 12b of the protective sleeve 12 can be designed such that an engagement of the thread 34 of the inner part 12a of the protective sleeve 12 with the respective connection base body 14a, 14b is not possible when the outer part 12b of the protective sleeve 12 is not connected to the connection base body 14a, 14b in a predetermined relative position.

The predetermined relative positions between the protective sleeve 12 or the outer part 12b of the protective sleeve 12 and a respective connection base body 14a, 14b can be configured in particular to transmit a rotational force exerted on the outer part 12b of the protective sleeve 12 onto the respective connection base bodies 14a, 14b. The two connecting devices 10, as shown in FIG. 1, after they have been inserted into one another, can thus also be locked with one another via a bayonet lock. For this purpose, the connection base body 14a can have on its outer side at least one groove, in particular three grooves, which is/are respectively configured to engage with a radially inwardly projecting pin-like projection which is formed, for example, on the outer part 12b of the protective sleeve 12.

As a result of the formation of the bayonet closure and the at least one predetermined relative position of the outer part 12b to the respective connection base body 14a, 14b, it can be ensured that the plug-and-socket combination of the two connecting devices according to the invention, the same fully connected to one another, is arranged such that the two outer parts 12a of the respective protective sleeves 12 also assume a relative position that is predetermined relative to one another, so that it is clearly recognizable from the outside that the plug-and-socket combination has been correctly connected. For this purpose, features can be arranged on each outer periphery of the outer parts 12b of the protective sleeves 12, which, in an axial main extension direction of the connecting devices 10, continue and/or supplement and/or are congruent with one another from an outer part 12b into the other outer part 12b.

In the embodiment shown, the outer part 12b of the protective sleeve 12 of each connecting device 10 is designed as a two-component injection-molded part, wherein at least sections of the radially outer side of the outer part 12b have a higher coefficient of friction compared to an inner side of the outer part 12b, so that any sliding between a hand of a user and the outer part 12b can be reduced or even prevented.

### CROSS REFERENCE TO RELATED APPLICATION

This application claims priority to German Patent Application No. 10 2022 114 441.0, filed in Germany on Jun. 8, 2022, the entire contents of which are hereby incorporated herein by this reference.

### TECHNICAL FIELD

The present invention relates to a connecting device for connecting electrical cables.

It is generally known from the prior art that electrical devices, such as headlights, can be connected using electrical cables in order to supply power to the electrical device. It is also generally known that two electrical cables can be connected to one another in order to obtain a lengthened electrical line.

However, these cable connections are often difficult to replace or repair in individual parts, if at all.

### SUMMARY

It is therefore the object of the present invention to provide a connecting device for connecting electrical cables which improves the ability to exchange parts.

According to the invention, this object is achieved by a connecting device for connecting electrical cables, comprising:
an arrangement of electrical contacts which are configured to enter on the plug-and-socket principle into electrically conductive contact with a complementary arrangement of electrical contacts, wherein a plurality of first electrical contacts is arranged around at least one second electrical contact, wherein each of the first electrical contacts has a substantially equal distance from the at least one second electrical contact, and
an arrangement of clamping units, wherein each clamping unit has at least two clamping receptacles, each of which is configured to receive an electrical conductor in a reproducible manner and in a lockable and releasable manner, in such a way that a release of the electrical conductor from a respective clamping receptacle in the locked state is prevented below a predetermined release force, and is allowed in the unlocked state,
wherein each of the electrical contacts is electrically connected to a clamping unit.

In this context, “reproducible” is intended to mean that an electrical conductor can be inserted repeatedly into a clamping receptacle, locked in the clamping unit, unlocked, removed from the clamping receptacle, and re-inserted (or, optionally, another electrical conductor is inserted) into the clamping receptacle, etc.

The connecting device is part of a plug-and-socket combination for connecting two electrical cables, wherein the connecting device according to the invention can be designed not only as a plug but also as a socket. In the case of the plug, the electrical contacts can advantageously be designed as pin-like projections. In the case of the socket, the electrical contacts can advantageously be designed as recesses.

In particular, the at least one second contact can be connected to a grounding line of the electrical cable, and/or the first electrical contacts can be connected to phases of the electrical cable.

An example of an embodiment according to the present invention is a 5- or 7-pole plug contact in which a contact, usually the grounding contact, is arranged centrally and the remaining 4 or 6 contacts are arranged in a circular manner around this central contact.

The connecting device according to the invention thus makes it possible for it to be disassembled without tools, that is to say without the use of a special tool, after which the clamping connections of the connecting device to the electrical cable can be released. Depending on the case in which a repair is performed, for example, a replacement connecting device can be connected to the electrical cable, or another, a shortened, or a repaired electrical cable can be connected to the connecting device.

The arrangement of clamping units can be overlapped radially on the outside by a cover which prevents direct and possibly unintentional contact with the clamping units and/or the electrical lines. In this case, the cover can consist of several, for example two or three, sub-components which are formed in a substantially identical manner and form the cover when they are fitted.

In the event that components of the connecting device according to the invention which are intended to be touched by a user are made of plastic, the plastic itself can provide a necessary insulation of the electrically conductive components with respect to the user. However, in the event that components of the connecting device according to the invention which are intended to be touched by a user are made of metal, a grounding of these components can be provided. In this case, a metal ring can in particular be arranged in contact with these components, which metal ring is in electrical connection with the above-mentioned grounding line. The connection of the metal ring to the grounding line can comprise a wire strand or a substantially rigid rib, which is integrated into, for example cast or overmolded onto, a connection base body formed from plastic. The metal ring can be arranged at an axial position at which it surrounds the arrangement of electrical contacts radially on the outside.

In a further development of the present invention, the arrangement of clamping units can comprise a plurality of first clamping units which are arranged around at least one second clamping unit, wherein each first clamping unit has substantially the same distance from the at least one second clamping unit. This arrangement of the clamping units can be an arrangement which is suitable for the arrangement of the electrical contacts—that is to say, the same arrangement. Furthermore, this arrangement can allow electrical connections to run substantially in a straight line between the electrical contacts and the clamping units. That is to say, such an electrical connection can run along a shortest path from an electrical contact to a respective clamping unit.

In this case, a free end of the at least one second clamping unit, viewed in an axial direction, can extend further outwards than the corresponding free ends of the first clamping units. This makes it possible to connect the corresponding electrical conductor to the central (second) clamping unit first and then to connect the first clamping units to the respective electrical conductors. As a result, a simplified assembly can be ensured.

In particular, the number of clamping units can correspond to the number of electrical contacts. A single respective electrical contact can thus be connected to a single respective clamping unit, such that the contact pattern of the plug or the socket can be reflected by the arrangement of the clamping units.

Furthermore, a clamping unit can have an elongated shape with two opposite longitudinal ends, and one of the two clamping receptacles of the clamping unit can be arranged at each longitudinal end, wherein in particular all clamping units can be arranged substantially parallel to one another. By means of the two clamping receptacles of a clamping unit, not only can an electrical conductor which is assigned to at least one of the electrical contacts be connected on the one side to the clamping unit without tools; but also an electrical conductor which is assigned to the electrical cable can be connected on the other side to a clamping unit without tools.

In possible embodiments of the present invention, the arrangement of clamping units can comprise a base body on which the clamping units are held. The base body can define fixed relative positions of the clamping units relative to one another, in particular by means of suitable receptacles for the clamping units.

In this case, the base body of the arrangement of clamping units may be made of plastic. In particular using an injection-molding process, the base body can thus be producible in a cost-optimized and weight-optimized manner.

The electrical contacts can be accommodated in a connection base body and be fixedly positioned relative to one another by the latter. A desired arrangement of the electrical contacts can thus be prespecified and maintained during the use of the connecting device.

In this context, the connection base body can be made of plastic. Here too, the base body can be producible in a cost-optimized and weight-optimized manner by the use of an injection-molding process. An embodiment of the connection base body made of plastic can also achieve an insulation of the arrangement of electrical contacts with respect to one another.

Advantageously, the base body of the arrangement of clamping units can be configured to engage with the connection base body in such a way that the base body of the arrangement of clamping units is at least rotationally secured, and in particular is also secured for translational movements, relative to the connection base body. This can be achieved, for example, by providing at least one projection on one of the two components, which is configured and arranged to engage with a corresponding recess on the respective other component. Damage to the electrical connections can be prevented in this way.

The connecting device can further comprise a protective sleeve which surrounds at least the base body of the arrangement of clamping units on the outer side thereof, and which is connectable to the connection base body. The connection of the protective sleeve to the connection base body can be watertight, in particular by using suitable sealing means.

The connection base body and the protective sleeve can be connected to one another via a threaded engagement, for example. For example, the connection base body can have an external thread with which an internal thread of the protective sleeve can engage.

In a further development of the present invention, the connecting device can further comprise a strain relief feature which is connectable to the protective sleeve and which is configured to prevent a displacement of a cable connected thereto, at least in an axial direction. For this purpose, the strain relief feature can comprise radially inwardly displaceable projections for engagement with a cable guided through the strain relief feature. The projections can, for example, be displaced radially inward by screwing the strain relief feature onto the protective sleeve. Alternatively or additionally, a ring can be arranged on the cable to be secured in an axially immovable manner, which ring is retained by the strain relief feature connected to the protective sleeve, at least in the axial direction away from the protective sleeve. As a result, loads on the clamping receptacles can be reduced or even prevented.

In possible embodiments of the present invention, the protective sleeve may comprise a substantially cylindrical body and a threaded ring provided with a thread, wherein the threaded ring is freely rotatable relative to the cylindrical body in a circumferential direction thereof and is secured in an axial direction thereof.

The protective sleeve can be constructed in several parts, in particular in two parts, wherein a radially inner part of the protective sleeve can be arranged substantially coaxial with a radially outer part and, in the mounted state, can run through it. In particular, the radially outer part of the protective sleeve can be configured to engage with the connection base body in such a way that the radially outer part of the protective sleeve is secured at least rotationally relative to the connection base body. In this case, in one of the predetermined connection positions of the radially outer part of the protective sleeve relative to the connection base body, a connection of the radially inner part of the protective sleeve to the connection base body can be prevented. This can be achieved, for example, by virtue of the fact that the radially inner part of the protective sleeve can only be guided through the radially outer part of the protective sleeve until the two parts reach abutment with one another.

This radially outer part of the protective sleeve can be produced using a two-component injection-molding process, and can comprise at least two different materials. The radially outer part of the protective sleeve can thus have sections with different coefficients of friction, and/or sections with different colors.

According to a further aspect, the invention can relate to a plug arrangement which comprises two connecting devices according to the invention that are complementary and connectable to one another on the plug-and-socket principle. These two connecting devices can be locked to one another using bayonet closure components that are suitable for one another.

### BRIEF DESCRIPTION OF THE DRAWINGS

It should be noted at this point that in particular the connection base body of the connecting device according to the invention can be made of metal, advantageously using a metal-casting process. The metal ring described further above can form an integral component of the connection base body. Furthermore, at least the second clamping unit can be provided with a securing element, such as an elastic band, a piece of elastic tubing, or an adhesive tape, in order to prevent unintentional opening of the clamping unit. To open the second clamping unit, the securing element must thus first be removed. Furthermore, the protective sleeve, in particular the outer part of the protective sleeve, can have at least one elastic buffer element. For example, an elastic rubber ring can thus be arranged at each longitudinal end of the outer part of the protective sleeve, which elastic rubber ring can dampen impacts on the protective sleeve—for example, caused by dropping the connecting device—and thus on the entire connecting device, and thus can reduce or even prevent damage.

### DETAILED DESCRIPTION

The present invention will be described in greater detail below by means of an embodiment with reference to the accompanying drawings. In the drawings:

FIG. 1 is a perspective exploded view of two connecting devices according to the invention, which are designed to be connectable to one another;

FIG. 2 is a perspective view of an arrangement of clamping units;

FIG. 3 is a side cross-sectional view of the arrangement of clamping units from FIG. 2; and

FIG. 4 is a cross-sectional view of a connecting device according to the invention.

Each of two connecting devices according to invention is denoted with reference number 10 in FIG. 1. The two connecting devices 10 of FIG. 1 are largely similar to one another, and differ in particular in that the connecting device 10 shown on the left in FIG. 1 is designed as a female connecting device (socket) and the connecting device 10 shown on the right in FIG. 1 is designed as a male connecting device (plug). Furthermore, it can be seen that each outer protective sleeve 12 of the connecting devices 10 is designed to be slightly different, in particular to have different lengths and external designs, so that a user of the connecting device according to the invention can determine as quickly as possible from the outside whether a connecting device he is using is a male or a female connecting device.

The connecting device 10, which takes the form of a female connecting device in FIG. 1, comprises a connection base body 14a, and the connecting device 10, which takes the form of a male connecting device in FIG. 1, comprises a connection base body 14b. The connection base body 14a has a central recess 16, which is configured to receive a corresponding projection 18 of the connection base body 14b. In the embodiment shown here, a plurality of pin-like protruding electrical contacts is arranged radially within the outer wall of the central projection 18 of the connection base body 14b, wherein this arrangement of electrical contacts has a plurality of first electrical contacts, which are arranged, for example, substantially along a circular path at a uniform distance from one another (of course, a non-uniformly spaced arrangement can be contemplated as well), and there is a second electrical contact which is arranged substantially at the center of this circular path. An arrangement of electrical contacts is also arranged radially within the outer wall which defines the central recess 16 of the connection base body 14a; in this embodiment, they are each designed as sockets for coming into electrically conductive contact with the pin-like electrical contacts of the connection base body 14b. For the arrangement of the electrical contacts, reference is therefore made to the above description.

In the following, the present invention will be further described with reference to the connecting device 10 shown on the left in FIG. 1, wherein all the features, effects and advantages can also be applied to the connecting device 10 shown on the right in FIG. 1.

The connecting device 10 further comprises an arrangement of clamping units 20, which will be described below in particular with reference to FIGS. 2 and 3.

The arrangement of clamping units 20 comprises a base body 22 formed from plastic, on which a plurality of clamping units 24 is arranged. The clamping units 24 each have two clamping receptacles 26, which are electrically connected to one another. Each clamping receptacle 26 comprises a clamping lever 28 which is configured to releasably lock a cable inserted into a respective clamping receptacle 26, and in particular to secure an electrical contact between the cable and the clamping receptacle 26.

As can be seen in particular in FIGS. 2 and 3, the clamping units 24 are arranged analogously to the electrical contacts described further above, so that a first plurality of clamping units is arranged in a substantially circular manner around a second clamping unit in the middle thereof. The free end of the second clamping unit shown on the left in FIGS. 2 and 3 projects further outwards relative to the corresponding free ends of the first clamping units, in particular by approximately half a total length of the second clamping unit. The second clamping unit can in particular be configured to be connected to a grounding line of an electrical cable, wherein the first clamping units can be configured to be connected to respective phases of the electrical cable. The described arrangement of the clamping units 24 thus makes it possible to connect the end of the second clamping unit shown on the left in FIGS. 2 and 3 to the cable in a simple manner first, and then to connect the phases of the electrical cable to the first clamping units. The clamping receptacles 26 of the clamping units 24 shown on the right in FIG. 3 are each connected, in particular using electrical cables, to one of the above-mentioned electrical contacts, which are either designed as sockets or as plugs. Of course, it is also possible for the electrical contacts to be each designed in such a way that their end pointing away from the cylindrical receptacle 16 or the projection 18 is configured to be connected directly to a clamping receptacle of a respective clamping unit 24.

As can be seen in particular in FIG. 2, the base body 22 of the arrangement of clamping units 20 has markings (in this case letters) in order to be able to distinguish the first clamping units 24 from one another in a simple manner.

The side of the base body 22 or of the first clamping units 24 shown on the right in FIGS. 2 and 3 is surrounded radially outside by a cover 30 which comprises two half shells 30a and 30b. In this way, the electrical connection of the clamping units 24 to the electrical contacts can be protected against unintentional manipulation. Furthermore, a latching device 32 formed on the cover 30 allows the arrangement of clamping units 20 to be positively secured to a respective connection base body 14a, 14b. Of course, the cover 30 can also be constructed from three or more partial shells which can be joined together in the circumferential direction to form the cover 30.

With reference to the above-mentioned protective sleeve 12, it can be seen in FIGS. 1 and 4 that the protective sleeve 12 is constructed from an inner part 12a and an outer part 12b, which are designed to be releasable from one another. The inner part 12a of the protective sleeve 12 is substantially a cylindrical hollow body which has an internal thread 34 at its one longitudinal end and an external thread 36 at its opposite other longitudinal end. The internal thread 34 is configured to be connected to a corresponding mating thread of a respective connection base body 14a or 14b. The external thread 36 is configured to be connected to a corresponding mating thread of a strain relief feature 38. The strain relief feature 38 has a central through-opening, the diameter of which substantially corresponds to the outer diameter of an electrical cable with which the connecting device 10 according to the invention is to be connected. In order to prevent a tensile force exerted on the electrical cable from being applied to the connection of the cable to the clamping units 24, a retaining ring can be attached to the cable at a suitable location, i.e., approximately at a distance from the free end of the electrical cable which corresponds to the distance of the first clamping units 24 from the strain relief feature 38, said retaining ring being clamped or screwed onto the electrical cable, for example. Due to the larger outer diameter of the retaining ring, the tensile force exerted on the electric cable is then directed from the electrical cable into the retaining ring, and from the same into the conical inner wall 40 of the strain relief feature 38, and from there into the protective sleeve 12 of the connecting device 10.

The outer part 12b of the protective sleeve 12 can in particular be designed such that it is connectable to the given connection base body 14a, 14b in only a limited number of relative positions, in particular at most three relative positions, more preferably in only a single relative position. In this case, each base body 14a, 14b, the inner part 12a of the protective sleeve 12, and the outer part 12b of the protective sleeve 12 can be designed such that an engagement of the thread 34 of the inner part 12a of the protective sleeve 12 with the respective connection base body 14a, 14b is not possible when the outer part 12b of the protective sleeve 12 is not connected to the connection base body 14a, 14b in a predetermined relative position.

The predetermined relative positions between the protective sleeve 12 or the outer part 12b of the protective sleeve 12 and a respective connection base body 14a, 14b can be configured in particular to transmit a rotational force exerted on the outer part 12b of the protective sleeve 12 onto the respective connection base bodies 14a, 14b. The two connecting devices 10, as shown in FIG. 1, after they have been inserted into one another, can thus also be locked with one another via a bayonet lock. For this purpose, the connection base body 14a can have on its outer side at least one groove, in particular three grooves, which is/are respectively configured to engage with a radially inwardly projecting pin-like projection which is formed, for example, on the outer part 12b of the protective sleeve 12.

As a result of the formation of the bayonet closure and the at least one predetermined relative position of the outer part 12b to the respective connection base body 14a, 14b, it can be ensured that the plug-and-socket combination of the two connecting devices according to the invention, the same fully connected to one another, is arranged such that the two outer parts 12a of the respective protective sleeves 12 also assume a relative position that is predetermined relative to one another, so that it is clearly recognizable from the outside that the plug-and-socket combination has been correctly connected. For this purpose, features can be arranged on each outer periphery of the outer parts 12b of the protective sleeves 12, which, in an axial main extension direction of the connecting devices 10, continue and/or supplement and/or are congruent with one another from an outer part 12b into the other outer part 12b.

In the embodiment shown, the outer part 12b of the protective sleeve 12 of each connecting device 10 is designed as a two-component injection-molded part, wherein at least sections of the radially outer side of the outer part 12b have a higher coefficient of friction compared to an inner side of the outer part 12b, so that any sliding between a hand of a user and the outer part 12b can be reduced or even prevented.

1. A connecting device for connecting electrical cables, comprising:
an arrangement of electrical contacts configured to enter into electrically conductive contact with an additional arrangement of electrical contacts in a plug and socket combination, wherein a plurality of first electrical contacts is arranged around at least one second electrical contact, wherein each of the first electrical contacts has a substantially equal distance from the at least one second electrical contact; and
an arrangement of clamping units, wherein each clamping unit has at least two clamping receptacles, each of the clamping receptacles configured to receive an electrical conductor in a reproducible manner, and in a lockable and releasable manner, in such a way that a release of the electrical conductor from a respective clamping receptacle in a locked state is prevented below a predetermined release force, and is allowed in an unlocked state,
wherein each of the electrical contacts is electrically connected to at least one of the clamping units.

2. The connecting device according to claim 1, wherein the arrangement of clamping units comprises a plurality of first clamping units which is arranged around at least one second clamping unit, each first clamping unit having a substantially identical distance from the at least one second clamping unit.

3. The connecting device according to claim 2, wherein a free end of the at least one second clamping unit extends further outwards in an axial direction than do the corresponding free ends of the first clamping units.

4. The connecting device according to claim 1, wherein the number of clamping units corresponds to the number of electrical contacts.

5. The connecting device according to claim 1, wherein a first clamping unit of the arrangement of clamping units has an elongated shape with two opposite longitudinal ends, and wherein one of the two clamping receptacles of the first clamping unit is arranged at each longitudinal end.

6. The connecting device according to claim 1, wherein the arrangement of clamping units comprises a base body on which the clamping units are held.

7. The connecting device according to claim 6, wherein the base body of the arrangement of clamping units is made of plastic.

8. The connecting device according to claim 1, wherein the electrical contacts are arranged in a connection base body and are fixed in position relative to one another by the same connection base body.

9. The connecting device according to claim 8, wherein the connection base body is made of plastic.

10. The connecting device according to claim 6:
wherein the electrical contacts are received arranged in a connection base body and are fixed in position relative to one another by the connection base body; and
wherein the base body of the arrangement of clamping units is configured to engage with the connection base body in such a way that the base body of the arrangement of clamping units is rotationally secured relative to the connection base body.

11. The connecting device according to claim 10, further comprising a protective sleeve which surrounds at least the base body of the arrangement of clamping units on an outer side thereof, and which is connectable to the connection base body.

12. The connecting device according to the claim 11, wherein the connection base body and the protective sleeve are connectable to one another via a threaded engagement.

13. The connecting device according to claim 11, further comprising a strain relief feature which is connectable to the protective sleeve and which is configured to prevent a displacement of a cable connected to the connecting device.

14. The connecting device according to claim 11, wherein the protective sleeve is constructed in two or more parts, wherein a radially inner part of the protective sleeve is arranged substantially coaxially to a radially outer part.

15. The connecting device according to claim 14, wherein the radially outer part of the protective sleeve is manufactured using a two-component injection-molding process, and comprises at least two different materials.

16. The connecting device according to claim 14, wherein the radially inner part of the protective sleeve extends through the radially outer part in an assembled state.

17. The connecting device according to claim 13, wherein the strain relief feature is configured to prevent displacement in an axial direction of the cable connected to the connecting device.

18. The connecting device according to claim 10, wherein the base body is configured to engage with the connection base body in such a way that the base body is also secured against translational movements relative to the connection base body.

19. The connecting device according to claim 5, wherein all of the clamping units are arranged substantially parallel to one another.
